(19) United States
(12) Patent Application Publication
(10) Pub. No.: US 2004/0226029 A1
(43) Pub. Date: Nov. 11, 2004

(54) Interface for distributed objects and development platform therefor

(76) Inventor: Andrew Anthony Gelme, Fitzroy Victoria (AU)

Correspondence Address: STITES & HARBISON PLLC, 1199 NORTH FAIRFAX STREET, SUITE 900, ALEXANDRIA, VA, 22314, US

(21) Appl. No.: 10/434,463

(22) Filed: May 9, 2003

(51) Int. Cl. G06F 9/44

(52) U.S. Cl. 719/328

(57) ABSTRACT

The invention provides a software development platform for allowing a software developer to develop an application that consists of one or more software modules, the platform being operable to independently provide each of the software modules with at least one component that allows the software modules to operate as distributed objects.

### FIELD OF THE INVENTION

The present invention relates to an interface for distributed objects in a software environment, a software development platform for building such interfaces, and a combination of such an interface and with software applications in the form of distributed objects, of particular but by no means exclusive application in the construction of interfaces for disparate electronic devices.

### BACKGROUND OF THE INVENTION

Existing distributed application development platforms are used to construct software applications that are designed to solve one or more domain-specific problems; in doing so, however, the applications additionally provide general functionality such as the security, failure, presentation and distribution of information. The main role of this application platform is to minimize the amount of non-domain specific tasks, so that the application designers and programmers can focus on the domain-specific tasks. An important result is that appropriate problems can be solved by this application platform in a single place.

Existing systems for building distributed objects include the .NET (TM) and the J2EE (TM) distributed application development platforms. Both the .NET (TM) and the J2EE (TM) platforms provide a roughly equivalent level of abstraction for the application developer, particularly in the area of web services, though they differ in the choices and qualities of various operating system platforms, languages, developer tools and services that they support or utilize.

The J2EE (TM) and the .NET (TM) platforms rely upon computer languages; the former is built in the Java (TM) programming language, while the latter is language neutral so typically utilizes, for example, the C# (TM), C++ (TM), C (TM) or VisualBasic (TM) programming languages. These platforms also provide an execution engine (respectively the Java (TM) Virtual Machine and the Common Language Runtime engine), and—in both cases—the language is compiled to an intermediate form that can be interpreted by the execution engine. The execution engine provides independence from a specific hardware processor implementation (such as the Intel (TM) x86 series) and provides additional features, such as security in the form of a sandbox to prevent unauthorized memory access. Third-generation languages (particularly the Java (TM) and C# (TM) languages) are fairly similar in the capabilities and expressive power that they offer the application developer.

As the J2EE (TM) platform only employs the Java (TM) programming language while the .NET (TM) platform can use multiple languages, the J2EE (TM) platform does not have to provide the illusion that all computer languages are equivalent, particularly in the key area of data types. This is important in producing true interoperability between components. The .NET (TM) platform, on the other hand, allows developers to choose different languages for different purposes, or simply employ a preferred language.

Both the .NET (TM) and the J2EE (TM) platforms provide an extensive set of class libraries that cover the spectrum of I/O (network, file), graphics, database, low-level security libraries. In both cases, there are well defined ways of developing and packaging components (in the case of the J2EE (TM) platform, both Enterprise Java Beans (TM) and regular JavaBeans (TM)).

Both the .NET (TM) and the J2EE (TM) platforms define a set of core services, such as web page request/content handlers and security services, such as .NET Hailstorm (TM) security service.

Finally, both these platforms are heavily promoting web services using protocols based on XML, SOAP, WSDL and UDDI.

However, the apparent strengths of these platforms also mean that the .NET (TM) platform has reduced cross-platform interoperability, while the J2EE (TM) Platform has reduced support for languages other than the Java (TM) programming language and reduced performance of crucial application functions, such as GUI toolkits. Further, developers of distributed applications using these and other existing development platforms are still required to deal with, amongst other things, component construction, component relationships, the handling of component failure, asynchronous semantics, thread decoupling, asynchronous component configuration, distributed component security and distributed component diagnosis.

### SUMMARY OF THE INVENTION

According to a first aspect of the present invention, there is provided a software development platform for allowing a software developer to develop an application that consists of one or more software modules, the platform being operable to independently provide each of the software modules with at least one component that allows the software modules to operate as distributed objects.

Thus, by using the software development platform the software developer does not have to worry about the various system level issues that relate to distributed software development (for example, lifecycle and state change). The software development platform takes care of the system level issues by independently providing the software modules with the component that allows the modules to operate as distributed software components. Consequently, the software developer can focus of application related issues. As will be understood by those in the art, while the term platform has been used throughout this document, the invention could equivalently be constructed as a framework.

Preferably the component comprises an interface for handling an operational call (or method call in object oriented languages) into or out of the component, and software capable of carrying out said operational call.

Preferably the platform allows the software developer to specify for said component a type, a name, and whether operational calls are in bound or out bound.

Preferably the platform is operable to programmatically or declaratively define a selection of components and software modules as a strongly encapsulated and self-contained distributed object.

Preferably the platform is operable to construct said component to perform one or more of thread control, operational call logging, distributed operational calls (such as, for example, remote method invocation), authentication, encryption and broadcasting of operational calls.

Preferably the platform is operable to construct said component to perform one or more of thread control, operational call logging, distributed operational calls, authentication, encryption and broadcasting of operational calls in a manner that is transparent to the software developer.

Thus, the components can be provided with functionality (provided as “Features” in the preferred embodiments) in a manner that is transparent or invisible to the software developer.

Preferably the platform is operable to provide one or more system defined components for performing one or more of lifecycle, usability, association management, persistence and configuration.

These system defined components are provided, in the preferred embodiments, in the form of system Facets.

Preferably the platform is operable to provide one or more system components for adding, modifying or removing any of the components and/or software modules that constitute a respective one of said distributed objects.

Preferably the respective one of said distributed objects includes said one or more system components for adding, modifying or removing.

Preferably the platform is operable to create, update or destroy any distributed object managed by said platform whilst said platform is operational.

Preferably the platform is a first of a plurality of such software development platforms and is operable to allow the transfer of a distributed object from said first platform to another of said plurality of platforms whilst said first platform and said other platform are operational.

Thus, the platform can be used to dynamically create nomadic distributed objects, and preferably provides meta-data to construct distributed objects and define their relationships with other distributed objects.

Preferably the platform is operable to develop user defined components that can be automatically linked to other of said components according to type or name.

Generally, the platform will be operable (and typically operated) to provide each of the software modules with a plurality of such components.

Preferably the platform is operable to alter the lifecycle state of any one of said distributed objects according to any association between said distributed object and any other distributed object and/or according to removal of said association.

Preferably the platform is operable to form one or more associations (in the form, for example, of references, linkages or dependencies) between any two of said distributed objects automatically.

Preferably the platform is operable to construct said component so as to queue in bound and/or out bound operational calls that are asynchronously invoked and thereby allow a current thread of control to continue processing without being blocked and a further thread of control to dequeue and continue the invocation of the operational call, whereby the invocation and execution of an operational call can be decoupled.

Preferably any one or more of said at least one component is constructed by means of the Jini (TM) platform.

Preferably any one or more of said one or more software modules is constructed by means of the Jini (TM) platform.

Thus, such distributed objects will comprise one or more software modules together with at least one component that allows the software modules to operate as the distributed objects. These distributed objects take the form, in the preferred embodiments described below, of “Meems”.

Preferably the platform is operable to provide each of the software modules with a plurality of such components.

Preferably the platform is operable to allow the programmatic or declarative definition of a compound distributed object comprising a plurality of said distributed objects, whereby said compound distributed object is strongly encapsulated and self-contained.

The platform is preferably constructed using the same techniques that it provides to the distributed application objects.

According to a second aspect of the present invention, there is provided a software application developed using the software development platform described above.

According to a third aspect of the present invention, there is provided a distributed object developed using the software development platform described above.

Preferably at least a part of said distributed object is constructed by means of the Jini (TM) platform.

According to a fourth aspect of the present invention, there is provided an application development method for allowing a software developer to develop an application that consists of one or more software modules, the method comprising the step of independently providing the software modules with at least one component that allows the software modules to operate as distributed software objects.

According to a fourth aspect of the present invention, there is provided a software development platform, operable to develop one or more software components that allow one or more software modules that constitute a software application to operate as distributed software components.

According to a fifth aspect of the present invention, there is provided a software development tool (preferably a visual tool), operable to develop one or more software components that allow one or more software modules that constitute a software application to operate as distributed software components.

According to a sixth aspect of the present invention, there is provided an electronic device provided with and controllable by an application developed by means of the software development platform described above.

According to a fifth aspect of the present invention, there is provided a software development framework for allowing a software developer to develop an application that consists of one or more software modules, the platform being operable to independently provide each of the software modules with at least one component that allows the software modules to operate as distributed objects.

Thus, the process of designing and implementing a distributed object can be vastly simplified, because all of the complex behaviour is embodied as modular pieces that transparently interact to provide correct operation. However, distributed system issues, such as failure between component relationships, are still presented to the application, but in a simple and consistent manner. Changes in the state of relationships between distributed objects alter the life-cycle state of the dependent distributed object. The distributed computer system focuses on the dynamic run-time relationships between distributed objects, providing standard mechanisms for group operations, combining distributed objects into more complex distributed objects and handling the complete and/or partial failure of relationships between distributed objects. There are also standard mechanisms for maintaining references to distributed objects and asynchronously decoupling threads of control used for method invocation between distributed objects. Distributed objects may fail permanently or temporarily depending on a number of factors, such as insufficient resources, failure of other components or inability to establish trustworthy relationships with other distributed objects. The invention provides a distributed computer system that provides a consistent process for dealing with failure that allows automatic recovery when the failing distributed objects (or replacements) are ready to function again.

### BRIEF DESCRIPTION OF THE DRAWINGS

In order that the invention may be more clearly ascertained, preferred embodiments will now be described, by way of example, with reference to the accompanying drawings, in which:

FIG. 1 is a schematic diagram of a distributed object or Meem according to a preferred embodiment of the present invention;

FIG. 2 is a schematic diagram of the features of a Facet of each of a pair of Meems of the embodiment of figured;

FIG. 3 is a schematic representation of two Facets (of respective Meems), both of type “Latch”, according to the embodiment of FIG. 1;

FIG. 4 is a schematic representation of the building and activation of a Meem according to the embodiment of the present invention, including the construction of its Facets;

FIG. 5 is a simplified flow diagram of a Meem LifeCycle according to the embodiment of FIG. 1;

FIG. 6 is a schematic diagram of a distributed system according to a second preferred embodiment with two dependent Meems;

FIG. 7 is a flow diagram of Meem Building according to the embodiment of FIG. 6;

FIG. 8 is a flow diagram of a Meem LifeCycle according to the embodiment of FIG. 6, showing both states and transition in that LifeCycle;

FIG. 9 is a flow diagram of Meem Dependency Resolution according to the embodiment of FIG. 6;

FIG. 10 is a flow diagram of a simple automation application according to the embodiment of FIG. 6;

FIG. 11 is a screen grab of a Meem Developer Tool according to the embodiment of FIG. 6;

FIG. 12 is a schematic diagram of an example of home automation by means of the embodiment of FIG. 6;

FIG. 13 is a schematic diagram of a further example of home automation by means of the embodiment of FIG. 6; and

FIG. 14 is an architectural diagram comparing the differences between existing techniques (left column) and the approach of the preferred embodiments of the present invention (right column).

### DETAILED DESCRIPTION

In a first preferred embodiment, the invention provides a distributed computer system, distributed software objects within that system (including their interfaces), and a software development platform for building those distributed software objects and the system. The platform prescribes a particular way of using—in this embodiment—the Java/RMI (Java Remote Method Invocation)/Jini (TM) platforms to form both interfaces (referred to below as “Facets”) and software object/interface combinations (referred to below as “Meems”).

This embodiment of the invention uses a number of different concepts, so some terms that will be referred to below are defined as follows:

Meem: a distributed object within the distributed system;

MeemPlex: a compound distributed object comprising a plurality of Meems bound together to be strongly encapsulated and self-contained and therefore appear as a single Meem;

Category: a means of grouping a number of Meems;

Dependency: the relationship between each pair of Meems; Facet: a software component in the form of an interface defining the operation of a Meem, where each Meem can have a plurality of such Facets;

Feature: a System defined function used by all Meems;

HyperSpace: a virtual space that maintains a collection of Categories;

Jini (TM): a services based distributed system framework;

Jini (TM) Lookup Service (JLS): a means of locating a Jini (TM) Service;

LifeCycleManager (LCM): a distributed object that maintains a collection of Meems;

MeemBuilder: a component that constructs a Meem from its definition;

MeemPath: uniquely identifies a Meem;

MeemRegistry: means for locating Meems;

MeemStore: storage for Meem Definitions and Content;

Reference: Unidirectional connection between Meems;

Virtual Machine (VM): Execution enviroment for the distributed system; and

Wedge: a discrete software component that implements part of a Meem's functionality.

The platform allows different types of software modules to be provided with suitable Facets and thereby be formed into distributed objects (i.e. in this embodiment, Meems) so that diverse devices that are controlled by means of those distributed objects can, despite their differences, communicate electronically with each other and so interoperate in a cohesive and consistent manner.

Examples of devices with software modules in the form of controller software that may includes distributed objects of this type are:

Electrical devices (switches, motors);

Security Devices (proximity card readers, biometric authentication, sensors, cameras);

Electronic multimedia devices (CD/DVD players, television tuners and screens, satellite television tuners);

Data (particularly represented in XML); and

Home automation systems

The platform also allows the user to ensure that necessary security is provided, so the above-mentioned interoperability is provided without compromising system integrity. The platform thus provides a set of protocols for disparate devices to interoperate, authenticate and communicate.

Meems

The platform includes tools for putting many of the requirements of distributed software systems into standard interfaces (Facets); such a Facet or Facets, in combination with a software module or modules, constitutes a new distributed software object or Meem according to this embodiment. This approach ensures that the framework is flexible and extendable, and that the distributed objects have interfaces that are consistent and interoperable, whilst removing the need to repeat coding tasks.

The software modules can be highly individual but the Meems interact, according to this embodiment, in a certain and predictable way. Each Meem has a minimum set of Facets, and each Facet a minimum set of common software development solutions (referred to as “Features”), which ensure that the Meems operate consistently in a distributed environment. A Meem 20 is shown schematically in FIG. 1, and comprises a software module in the form of a software implementation (or ‘IMPL’) 22 and six Facets (each of which deals with an area of distributed software development): Persistence Facet 24, Events Facet 26, State Facet 28, Configuration Facet 30, Location Facet 32 and Lifecycle Facet 34.

Meems thus interact with common interfaces and always have common minimum solutions for distributed software requirements.

Every Meem has an IMPL, which—as it provides the fundamental functionality of the Meem—is the core identity of the respective Meem and defines what the Meem is and what it can do. The IMPL is defined by the software developer.

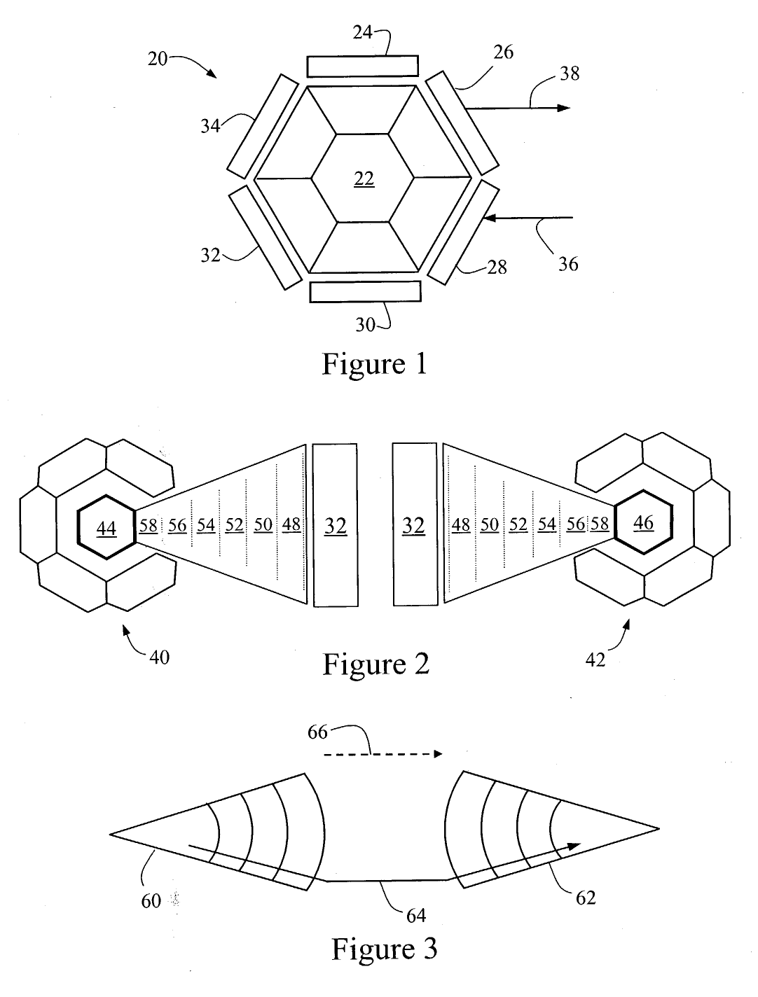

The Features of each Facet are provided by the platform, but can be extended by the software developer. The Location Facet 32, for example, is provided with the Features Leasing, Threading, Logging, Usability, Transaction and Security. These Features are depicted schematically in FIG. 2, in which two Meems 40, 42 (corresponding respectively to the controlling software of a media player and an MP3 player) include respective IMPLs 44, 46. The Meems 40, 42 each have the Facets listed above; the Location Facet 32 in each case is shown expanded and includes the Features: Leasing 48, Threading 50, Logging 52, Usability 54, Transaction 56 and Security 58.

Thus, the platform—by means of the Meem approach—constitutes a modular solution, where application developers work at a higher level of abstraction. The Facets of a Meem collectively provide the interface through which method (or function) calls are made, both into and out of the Meem. Referring to FIG. 1, the Facets thus intercept all in-bound and out-bound method calls 36, 38 and ensure that a set of operations (the Features) are consistently applied to those method calls.

Facets

Each Facet is a Java (TM) interface type, with a corresponding part of the IMPL that provides the behaviour (functionality) for that Facet. The same Java (TM) interface may be used for different Facets, because different behaviour may be associated with different Facets of the same interface type. Facets can be named in order to distinguish between Facets within the same Meem with identical Java interface; such Facets also use different names to indicate different behaviour. Facets are declared as providing either in-bound or out-bound method calls to the Meem.

Meems can refer to other Meems by declaring Dependencies between similarly typed Facets of the two Meems. In this fashion, the out-bound Facet of one Meem can be connected to (i.e. depend upon) the in-bound Facet of another Meem. Similarly, information can flow in the opposite direction: the in-bound Facet of one Meem can depend upon the out-bound Facet of another Meem.

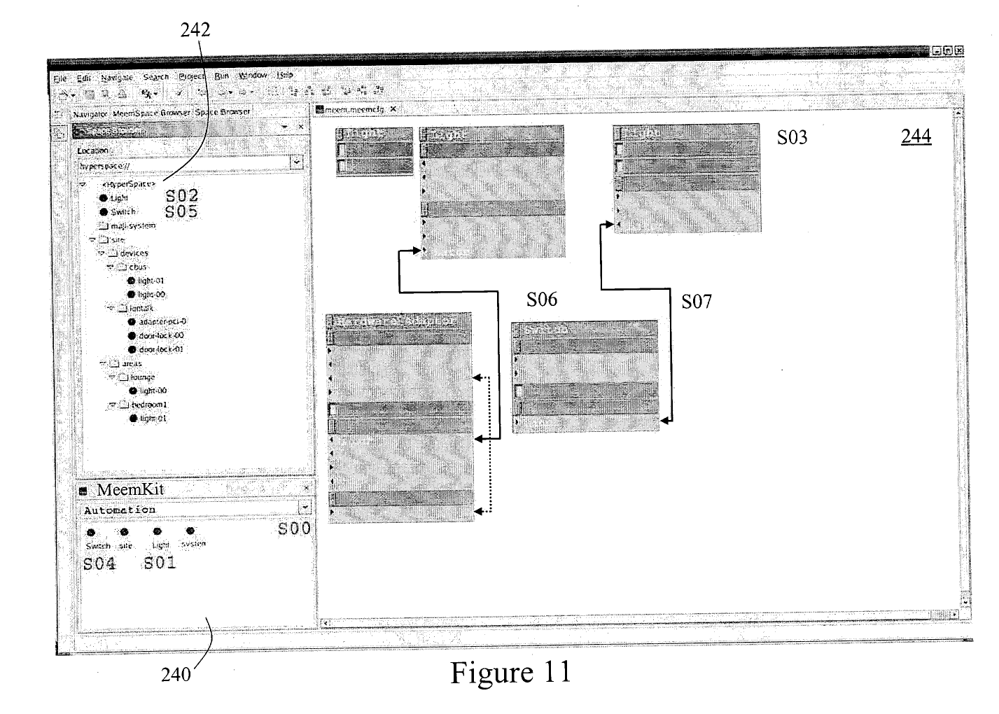

Thus, FIG. 3 is a schematic representation of two Facets 60, 62 (of respective Meems), both of type “Latch”. First Facet 60 has the name “switch” and second Facet 62 the name “light”. The direction of a method call 64 is “out” from first Facet 60 and “in” to second Facet 62. The Dependency 66 is thus from first Facet 60 to second Facet 62. (A more detailed example of Meems of this type is described below by reference to FIGS. 10 and 11.)

Meems, through the use of Facets, extend the utility of, in this embodiment, the Java (TM) language in three ways:

There is a well-defined way for a Meem to have multiple interfaces of the same type and for external parties to distinguish between them;

The Facets (viz. interfaces) of a Meem can be out-bound, not just in-bound method calls; and

There is a well-defined means for specifying the relationship (Dependencies) between Meems, which is both dynamic and distributed.

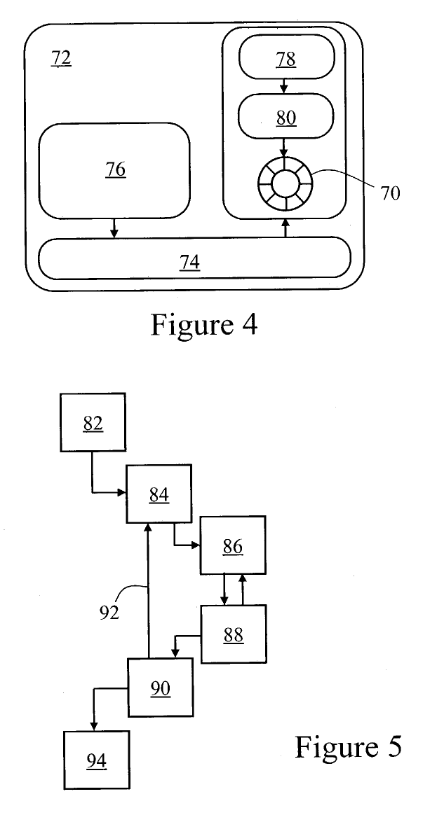

Referring to FIG. 4, according to the system of this embodiment a Meem 70 is activated (such as by being loaded into a Java (TM) Virtual Machine) by a LifeCycleManager 72, a MeemBuilder 74 uses a MeemDefinition 76 to construct all the Facets and their implementations, and the Meem 70 is built on-the-fly. The Java (TM) Dynamic Proxy Object is used, so that a single reference 78 is provided to the client of the Meem. Through this reference 78, all of the Facets are accessible via a mapping performed by the Java (TM) Dynamic Proxy Object 80.

The platform defines a collection of system Facets and Features that are used to build every Meem. These system Facets and Features provide default implementations of the behaviour that the platform expects that all Meems will provide. If neccessary, a developer can provide a different implementation of a system Facet, on a per Meem, per MeemPlex (i.e. a complex of Meems, discussed below) or system-wide basis. This allows a system designer to model (preferably using visual tools) his or her application around Meems and design application specific Facets and the relationships (viz. Dependencies) between those Facets. The application developer provides implementations of the required application specific Facets. At runtime, application specific Facets are combined with the system provided Facets to build Meems that function as complete distributed objects.

For a given application domain, application specific Facets can be designed that are then declared to be part of every application specific Meem. For example, for multimedia applications, all multimedia Meems might include a MediaStream Facet.

Thus, a key distinguishing feature of the platform of this embodiment is that a component built by means of the platform (i.e. a Meem) actually provides all the behaviour required of a complete distributed component, through the use of system provided Facets and Features. This allows the system to be extended in a highly modular fashion.

The following list summarizes the behaviour embodied by the system provided Facets.

1. Lifecycle

Meems have a well-defined life-cycle that defines the various states through which a Meem may transition. The basic elements of the life-cycle of a Meem is illustrated schematically in FIG. 5. This life-cycle are discussed in greater below (by reference to FIG. 8), as are Dependencies.

Initially, a Meem is created 82 by constructing a MeemDefinition and some initial MeemContent. A Meem that is created, but not yet activated, will be persisted without an instance of the Meem existing in any Java (TM) Virtual Machines.

Activating 84 a Meem involves using a LifeCycleManager to build an instance of the Meem and attempt to make it “ready” (usually by resolving any required Dependencies). A LifeCycleManager may simply activate all the Meems for which it is responsible, or it may only activate a Meem as required.

Once the Meem's required Dependencies are resolved and its specific resources are acquired, the Meem moves to the ready state 86. The LifeCycleManager registers any Meems that are ready with a MeemRegistry, so that clients can locate the Meem.

Whenever the Meem's required Dependencies are not all resolved or some specific resources are lost, then the Meem becomes “not ready” 88. The LifeCycleManager removes the Meem from the MeemRegistry and it ceases to be available for use. If a Meem has an unrecoverable error, then it moves from the ready to the deactivated state 90 and must be re-activated 92 before it can become ready again.

Alternatively, the LifeCycleManager can decide that a Meem is no longer needed and can deactivate it 90. This means that there is no longer an instance of the Meem running within a Java (TM) Virtual Machine.

Finally, a Meem can be destroyed 94, which means that it no longer exists within the system.

The LifeCycleManager needs to interact with a Meem, so that it can inform the Meem of state changes that it needs to enforce. Conversely, the Meem must inform the LifeCycleManager of any state changes that are initiated from within the Meem. These interactions are performed via the LifeCycle and LifeCycleClient Facets.

2. Usability

A normally functioning Meem may move smoothly between being activated, ready, not ready, deactivated, activated, and so on. However, when it encounters an unrecoverable error, in order to ensure liveliness of the applicaion state all clients should be informed. This task is performed by the Usability Facet.

3. Configuration

Meem attributes can be either loaded from persistent storage or asynchronously received from other Meems as properties. The Configuration Facet uses those properties and Java (TM) Reflection to set the attributes in the Meem instance automatically.

4. Persistence

The Meem can be requested, usually by the LifeCycleManager, to persist its attributes. The Persistence Facet provides a default mechanism for performing this function, using Java (TM) Reflection, and MeemStore for storing the MeemDefinition and MeemContent.

5. Dependencies

The relationship between Meems is defined by Dependencies. Dependencies may be either strong or weak. A strong Dependency is one that must be resolved and bound before the Meem can be made ready. A weak Dependency can be bound or unbound, without affecting the Meem state. However, the Meem must be prepared to handle unbound weak Dependencies.

The Dependency Facet manages the resolution of MeemPaths (using the SearchManager and Spaces), and the location of Meems via the MeemRegistry.

6. Resources

A Meem may have specific resources, such as database connections, that need to be acquired for the Meem to be ready. The application developer may replace the system defined Resource Facet to provide custom code that manages the Meem's resources and informs the LifeCycleManager accordingly.

Features

Between any two Meems in an operational environment, there are common operations that occur on every method call. For example, remote method call semantics may be required (dealing with partial failure) and security access should be checked. The platform provides these common operations as Features.

Features intercept every method call between two Meems. There are a number of different situations, which will be handled using a different sequence of Features:

In-bound versus out-bound method calls;

Local versus remote method calls; and

Calls between MeemPlexes as against within a MeemPlex.

In some cases, the difference is simply one of optimization. The full sequence of Features could be used, but there is no additional value and a definite performance cost in doing so. For example, there may be no need to check security between two Meems operating within the same MeemPlex. Alternatively, there is no need to use remote method call semantics between two Meems operating within the same Java (TM) Virtual Machine.

Features are implemented as modular pieces of functionality, and the implementation of each Feature is provided by means of the system provided Facets. However, the key difference between a Facet and a Feature is that the Facets are the visible interconnection points (viz. Dependencies) between Meems, whereas Features are invisibly applied on every in-bound and out-bound method call. The modularity of Features allows flexibility and extensibility so that the Meem environment can cater for different situations as well as provide different or improved functionality in the future.

The following list summarizes the behaviour embodied by the system provided Features.

1. Distributed

This Feature provides proxies for handling local and remote method calls. It deals with communication failures with remote Meems and uses Java RMI leasing to ensure liveness between dependent Meems.

2. Thread Decoupling

To avoid design and implementation errors due to threading problems, all interactions between Meems are—by default—thread decoupled. Consequently, method calls to provider Meems return immediately and the operation is continued on another thread. By definition, all Facet method calls need to be designed to operate asynchronously. Information flow in both directions is provided by using Dependencies to refer to a callback Facet.

By default, Meems are assumed to be single threaded and the in-bound method queue is throttled accordingly. Meem developers may declare that their Meem has been designed for multi-threading (reentrant code).

3. Security

All interactions between Meems can be checked for appropriate access privileges. The Security Feature provides a high-level abstraction for access and denial, which is configurable. It also allows for delegation of authority with constraints, so that one Meem may act on behalf of another Meem. This security is built upon the layers of security already provided by the Java (TM) language, JSSE (TM), JAAS (TM) and Jini (TM) (Davis) technologies.

4. Flight Recorder

This Feature records in-bound and out-bound method calls, including the Facet type and name, method name, parameters and direction. The Flight Recorder provides a mechanism for the diagnosis of distributed object interaction problems.

5. Transaction

When multiple Meem interactions need to be performed atomically, this Feature looks after the transaction management.

Meem Anatomy

Each Meem Server launches with at least one LifeCycleManager, which defines the lifecycle of a Meem. Facet and Feature factories are then constructed to define the common elements of all Meems that will exist within the lifecycle of the MeemStore.

Stored and discovered Meems are then enabled within the system.

Two or more Meems can be combined to form more complex constructs or “MeemPlexes”. MeemPlexes act in the same way as Meems, in a manner analogous to the way in which complex software objects can be constructed from simpler objects.

A MeemStore can encompass many Java (TM) Virtual Machines. As long as a Meem ‘exists’ it will survive across Java (TM) Virtual Machine invocations.

All objects in a MeemStore are themselves Meems, the platform is built with its own technology.

A key concept in this embodiment is a Space (of which a MeemStore is one example). Different types of Spaces are used to store Meems, including both their Definition and Content, as well as various types of relationships between Meems. There are two basic types of Spaces, one that is used for storage and one that is used for relationships between Meems.

A MeemPath is the means by which a Meem is located in one of the available Spaces. There are a number of different circumstances, in which a MeemPath is used. For example, a LifeCycleManager is given a MeemPath which indicates those Meems that it is responsible for activating.

Further, a Dependency between Meems is specified by a MeemPath that is resolved to one or more Meems whose references need to be provided back to the depending Meem. To resolve a MeemPath into one or more Meems, is the job of the SearchManager. The SearchManager knows about the available Spaces and hands the MeemPath to the appropriate Space, expecting a more resolved MeemPath in return. If the SearchManager determines that the MeemPath can be resolved into an individual Meem, then that Meem can be bound using the MeemRegistry.

A MeemPath may refer to a special type of Meem, known as a Category. A Category contains a list of MeemPaths, and is effectively this embodiment's way of defining a group of Meems. All types of Spaces can use Categories to indicate that they are providing a group of Meems, rather than just an individual Meem.

Spaces that maintain Meem relationships can only return MeemPaths thereby, in effect, translating one MeemPath into a set of MeemPaths. Ultimately, a MeemPath needs to refer to a Space that is used for the actual storage of a Meem Definition and its Content. At that point, an unbound Meem can be constructed that can be potentially bound to an activated and ready instance of the Meem running inside of a LifeCycleManager. All available Meems are registered with the MeemRegistry.

Two Spaces that are essential to the operation of this embodiment are:

1. MeemStore: a storage Space that uses the Meem's UUID (Univeral Unique IDentifier) as a key to locate the Meem's Definition and Content; and

2. HyperSpace: a network of uni-directional links between Meems>that can be used to group Meems into various application specific views.

MeemStore

MeemStore provides the mechanism by which Meems are stored. MeemStore stores both the MeemDefinition and the MeemContent. The MeemStore MeemPath uses the Meem UUID as the key to locating a particular Meem. For example:

MeemStore://ffffffff-ffff-ffff-ffff-ffffffffffff

MeemStore is a flat (i.e. linear) Space that does not provide any higher level abstraction for organizing Meems. However, a Category Meem stored in MeemStore could contain a list of MeemPaths refering to other Meems in MeemStore, allowing simple grouping to occur.

HyperSpace

HyperSpace provides a directory-like structure for maintaining the relationships between various Meems. HyperSpace is a Category, which acts as a starting point for following MeemPaths throughout the rest of the Space. A HyperSpace MeemPath provides a delimited list of Categories that may be followed to locate a specific point in the HyperSpace. For example:

hyperSpace://site-geekscape/area/backyard/cubbyhouse

Each name that appears as part of the HyperSpace MeemPath is a Category, except for the final name, which may be either a Category or a non-Category Meem.

HyperSpace does not store any Meem Definition or Content. Category Meems can contain MeemPaths that refer to other Spaces, in particular storage Spaces, such as MeemStore. This means that the same Meem may be referenced in many different Categories. HyperSpace can be used to organize the contents of a MeemStore Space to have different views, depending on the varying application perspectives.

While the above description introduces the fundamental concepts, components and functionality of this embodiment, a more detailed description of a distributed system according to a further embodiment and its most important Features is now provided.

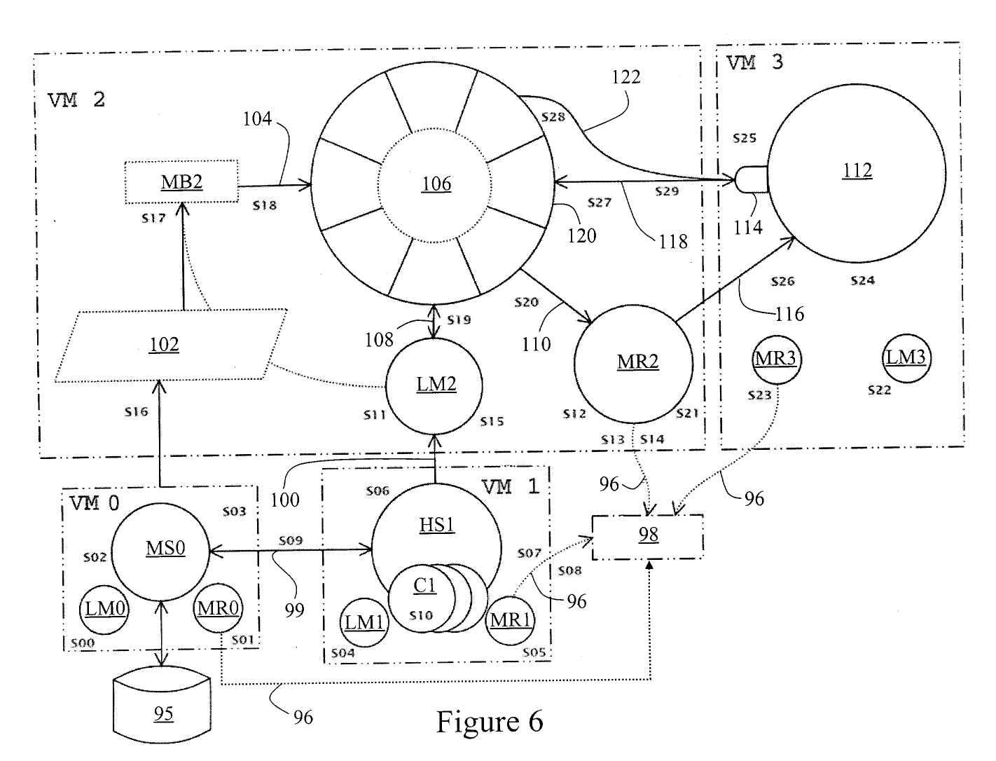

FIG. 6 is a high-level schematic diagram of a distributed system according to the second preferred embodiment with two dependent distributed objects (viz. Meems) during system initialization and the subsequent creation of the Meems. One Meem depends upon the other and there is information flow in both directions.

The distributed system of this embodiment involves a number of Virtual Machines (VMs), two of which contain system components, such as MeemStore and HyperSpace; each of the other two contains a distributed application object, namely, “Target Meem” and “Client Meem”. The whole system is in communication with persistent data storage 95.

Thus, referring to FIG. 6, the various components are identified, as are the sequential steps involved in system initialization and Meem creation.

Step S00 involves creating a LifeCycleManager in VM0 (i.e. Virtual Machine 0). All VMs that create and run Meems require a LifeCycleManager (LCM). The LifeCycleManager maintains a collection of Meems, especially paying attention to changes in their LifeCycle state (a process described in greater below). The LifeCycleManager will be registered with the MeemRegistry.

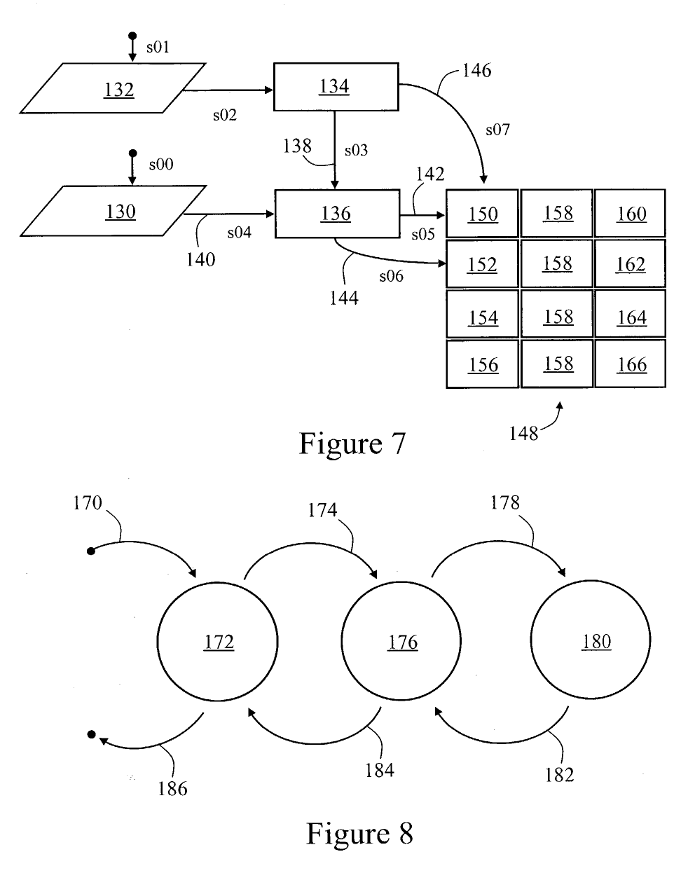

Step S01 involves creating a MeemRegistry MR0 in VM0. All VMs that participate in the system require a MeemRegistry to both register (and export) their Meems, as well as locate other Meems. The MeemRegistry has its LifeCycle maintained by the LifeCycleManager. The creation of a Meem is further described in steps S12 to S20, and in greater detail below by reference to FIG. 7.

In Step S02 a MeemStore MS0 is created in VM0. A MeemStore stores the definition and content of the Meems. Each Meem can be individually located within the MeemStore by its MeemPath. The MeemStore is unstructured, such as linear with no hierarchy. Only a single MeemStore is required. However, multiple MeemStores can operate concurrently and they are effectively consolidated, so as to appear as a single MeemStore. The MeemStore is registered with the MeemRegistry. The MeemStore has its LifeCycle maintained by the LifeCycleManager.

In Step S03, MeemRegistry MR0 in VM0 registers 96 with the Jini (TM) framework. That is, the MeemRegistry MR0 exports itself as a Jini (TM) Service to the Jini (TM) Lookup Service 98 so that Meems can be distributed across multiple VMs. Every Meem has a Scope that determines the extent to which a Meem can be located, such as only within its VM or between VMs on a LAN. (Step S08 describes the process of a Meem being located.)

In Step S04, a LifeCycleManager LCM1 is created (as per Step S00) in VM1.

In Step S05, a MeemRegistry MR1 is created (as per Step S01) in VM 1. To demonstrate a situation in which the system is itself distributed, this embodiment includes MeemStore MR0 and a HyperSpace HS1, which are two vital pieces of infrastructure, operating in different VMs (respectively VM0 and VM1). Like most important parts of the system, MeemStore MS0 and HyperSpace HS1 are themselves Meems, which means that they can be easily distributed on different computer hardware systems.

Thus, in Step S06 HyperSpace HS1 is created in VM1. HyperSpace HS1 stores the relationship between Meems. As mentioned above, a HyperSpace maintains a collection of Categories C1. A Category is a key object structure, and is a mechanism for maintaining a set of Meems that are similar in some fashion. Each Category has a number of entries, each of which is a MeemPath that provides a means for locating the Meem. Since a Category is itself a Meem, a Category may link to other Categories and well as regular Meems. Meems may appear in multiple Categories. HyperSpace and Categories are similar to the World Wide Web and web pages, in that web pages contain unidirectional hyperlinks to other web pages, and so on. HyperSpace is itself a Category (and a Meem), which acts as a starting point for following MeemPaths throughout the Space, by holding entries that refer to other important (top level) Categories. For more details, see step S10.

In Step S07, MeemRegistry MR1 in VM1 registers 96 with the Jini (TM) framework (as per Step S03).

In Step S08, HyperSpace HS1 in VM1 locates MeemStore MS0 via MeemRegistry MR1. HyperSpace HS1 only maintains the relationships between Meems; it does not provide storage for the Meems. This also applies to the Categories C1 that HyperSpace HS1 maintains. HyperSpace HS1 uses MeemStore MS0 to store the Category definitions and contents. This Step includes a number of substeps:

Substep S08a: HyperSpace H1 asks MeemRegistry MR1 for MeemStore MS0;

Substep S08b: MeemRegistry MR1 determines that MeemStore MS0 is not local;

Substep S08c: MeemRegistry MR1 locates other MeemRegistries (MR0, MR2, MR3) via the Jini (TM) framework;

Substep S08d: Other MeemRegistries (MR0, MR2, MR3) are asked for a MeemStore; and

Substep S08e: The MeemRegistry MR0 in VM0 provides a remote Reference to the MeemStore MS0.

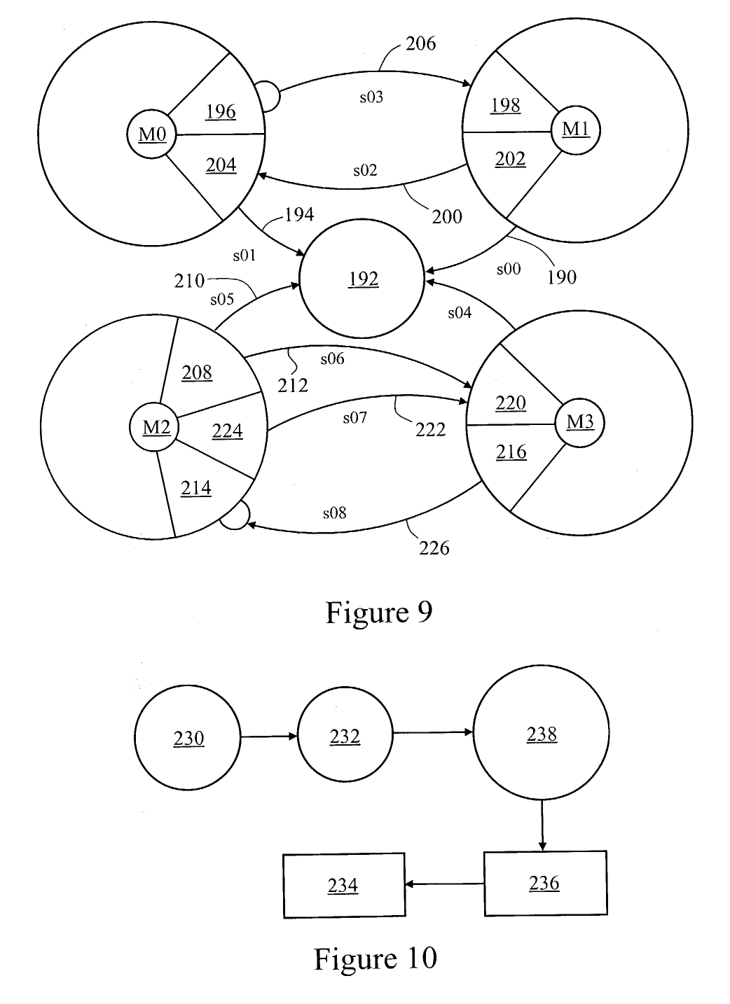

The mechanism for one Meem to refer to another Meem so that method invocations can be made is known as a Dependency. Step S25 describes the Dependency mechanism. This process is also described in greater detail below by reference to FIG. 9.

In Step S09, HyperSpace HS1 restores 99 Categories C1 using MeemStore MS0. Whenever Meems depend upon a Category, HyperSpace HS1 dynamically restores the desired Category by using the definition and contents that have been previously stored in MeemStore MS0.

In Step S10, Categories C1 group similar Meems. Most applications will need to group Meems together. Categories dynamically maintain a list of entries. Whenever an entry is added or removed, all Meems that depend upon that Category are notified.

In Step S11, a LifeCycleManager LCM2 is created (as per Step S00) in VM2.

In Step S12, a MeemRegistry MR2 is created (as per Step S01) in VM2.

In Step S13, MeemRegistry MR2 in VM2 registers 96 with the Jini (TM) framework (as per Step S03).

In Step S14, LCM2 in VM2 locates HyperSpace HS1 via MeemRegistry MR2. The LifeCycleManager LCM2 depends upon a Category to be used in step S15. To acquire the Category, the LifeCycleManager LCM2 needs a Reference to HyperSpace HS1, which happens to be in VM1. The sequence of “location” operations is similar to Step S08.

In Step S15, LCM2 determines which Meems to manage 100. All LifeCycleManagers depend upon a specified LCM Category (typically in HyperSpace) that contains a list of Meems to be maintained by a LifeCycleManager in a particular VM. The LifeCycleManager uses HyperSpace to acquire a MeemPath to the LCM Category, upon which it depends. As Meems are added or removed from the LCM Category, it dynamically notifies the LifeCycleManager, which either creates or destroys the Meem.

The process of creating a Meem is described in Steps S16 to S21:

In Step S16 the Meem Definition 102 (including Wedge Definition, FacetDefinition and DependencyDefinition) is acquired. The LifeCycleManager LCM2 is responsible for the complete LifeCycle of a Meem, from creation through to destruction (see FIG. 5). It performs this process by coordinating the actions of a number of other processes. For a given Meem, the first step is to use the MeemPath extracted from the Category entry provided in Step S15. This MeemPath is used to locate the MeemDefinition in MeemStore MS0;

In Step S17, the MeemDefinition is given to the MeemBuilder MB2. The LifeCycleManager LCM2 provides a MeemDefinition to the MeemBuilder MB2, which uses that Definition to assemble all the defined pieces into a single, seamless, encapsulated distributed component, the Meem;

In Step S18, the MeemBuilder MB2 constructs 104 the Target Meem 106. All of the Wedges defined by the application for this Meem 106, plus the predefined system Wedges are created. For each Wedge, the various in-bound and out-bound Facets are created. For each Facet, a Dependency on other Meems may be attached. This process is described in greater detail below by reference to FIG. 7;

In Step S19, the LifeCycleManager LCM2 maintains 108 Target Meem 106. The MeemBuilder MB2 returns the newly constructed Meem back to the LifeCycleManager LCM2. The LifeCycleManager LCM2 assigns a MeemPath to the Meem 106, based on the MeemStore MS0 used by the LifeCycleManager LCM2 for Meem storage. This MeemPath can be used by other Meems to uniquely locate this new Meem 106;

In Step S20, the Target Meem 106 registers 110 with MeemRegistry MR2, so that the Target Meem 106 can be located by other Meems. A Weak Reference to the Target Meem 106 is added to the MeemRegistry. Apart from the TargetMeem Reference maintained by the LifeCycleManager LCM2, all other TargetMeem References distributed throughout the system are Weak or Remote References. This means that the Target Meem 106 can be entirely destroyed and completely removed by the LifeCycleManager, regardless of any other References; and

In Step S21, the MeemRegistry MR2 notifies MeemRegistry Clients. The Target Meem 106 is added to the MeemRegistry MR2. Other Meems can depend upon the MeemRegistryClient Facet to receive notifications regarding Meem additions and removals from the MeemRegistry MR2. This mechanism allows one Meem to uniquely locate another Meem by its MeemPath.

In Step S22, a LifeCycleManager LCM3 is created (as per Step S00) in VM3.

In Step S23, a MeemRegistry MR3 is created (as per Step S01) in VM3. The MeemRegistry MR3 registers 96 with the Jini (TM) framework (as per Step S03).

In Step S24, a Client Meem 112 is created (as per Steps S14 to S21) in VM3.

In Step S25, the Client Meem 112 has a Dependency 114 on the Target Meem 106. A Dependency between Meems is resolved into a unidirectional Reference. Either Meem can depend upon the other and establish a flow of information, independent of the direction of the Dependency. Dependencies between Meems can be mutual, as described in steps S26 to S29.

In Step S26, the Client Meem 112 locates 116 the Target Meem 106. The Client Meem 112 depends upon the MeemRegistryClient Facet of the MeemRegistry MR3 in VM3 (created in Step S22). A Filter is used that contains the MeemPath of the Target Meem 106. Since MeemRegistry MR3 does not have a local Reference to the Target Meem 106, MeemRegistry MR3 checks with all the other MeemRegistries (MR0, MR1, MR2) discovered via the Jini (TM) Lookup Service 98. The MeemRegistry MR2 in VM2 responds with the Target Meem 106 Remote Reference, which is then handed back to the Client Meem, via the MeemRegistry MR3 in VM3.

In Step S27, the Client Meem 112 acquires a Reference 118 to the desired Facet 120. Using the Target Meem 106 Reference acquired in Step S26, the Client Meem 112 requests a Reference to the Target Meem Facet 120 specified in the Dependency. This Target Meem Facet 120 Reference is then used to update the out-bound Facet field in the Client Meem Wedge implementation. This allows the Client Meem 112 to send messages to the Target Meem 106.

In Step S28, the Target Meem 106 resolves a Dependency 122 on the Client Meem 112. In this example, the Client Meem 112 has another Dependency 112 on the Target Meem 106 that defines a Reference from a specific out-bound Target Meem Facet to an in-bound Client Meem Facet. The Client Meem 112 sends this Dependency to the Target Meem 106, which then resolves it into a Reference to the specified Client Meem Facet (in a manner similar to Step S27).

In Step S29, messages are sent between the Client Meem 112 and the Target Meem 106. Now that the Client and Target Meems have References to each other, messages can be asynchronously sent in either direction. If, at any time, either Meem 106, 112 or the network should fail, the References are automatically removed and the Dependencies become unresolved. If either of the Dependencies are “strong”, then the Client Meem 112, which declared the Dependency, will become “not ready” 88 (see FIG. 5). This effect will ripple throughout the system, causing Meems to become dormant, until the problem is resolved.

The following sections describe specific processes of this embodiment in greater detail, including Meem Building, Meem LifeCycle, Meem Dependency Resolution, Asynchronous thread decoupling and the Meem Developer Tool

Meem Building

As discussed above, Meems are the basic building blocks of the distributed system of this (or the first) embodiment and of the applications running as part of that system, while Meems comprise a number of more fundamental parts, known as Wedges, Facets and Dependencies. The MeemDefinition comprises all the Definitions of those fundamental parts. The MeemBuilder can take a MeemDefinition and dynamically create a new instance of a Meem, during the run-time of the system. The MeemDefinition contains an identifier, one or more WedgeDefinitions, a Scope that determines the extent of a Meem's visibility and a version number. A Wedge provides part of the implementation behaviour of a given Meem. The WedgeDefinition contains an identifier, zero or more FacetDefinitions, an implementation class name and a list of fields that describe the persistent state of that Wedge. A Facet is an external interface of the Meem that can either receive in-bound method invocations or deliver out-bound method invocations, but not both. A FacetDefinition contains an identifier, an indicator of whether an in-bound Facet requires initial state and a single DependencyDefinition. A Dependency defines a dynamic relationship with another Meem. The direction of the resulting Reference (flow of information) can be in the same or opposite direction to that of the Dependency. The DependencyDefinition contains a MeemPath to locate the other Meem, a Scope that determines the extent of locating the other Meem and a Dependency type. Even though a given Meem Facet has only a single Dependency, it may depend on multiple other Meems, if the Dependency is on a Category Meem (grouping concept) and the Dependency type is either “strongMany” or “weakMany”. (Dependencies, their types and their resolution are described in greater detail below by reference to FIG. 9.) Once a Meem is constructed, one of the system defined Wedges provides the MetaMeem (in-bound) and MetaMeemClient (out-bound) Facets. These Facets can be used during the system run-time to dynamically add new or remove any of the Definitions that describe parts of the Meem.

This allows Wedges, Facets or Dependencies to be added or removed whenever the Meem is in “active” state 84. Importantly, a distributed object—which can be dynamically created, altered and destroyed—embodies all of the required system and application behaviour as a single, seamless and strongly encapsulated whole.

FIG. 7 is a flow diagram of Meem Building according to this embodiment, and depicts the process by which a Meem is constructed.

In Step S00, a Definition 130 for the system defined Wedges is created. All Meems created by the system will consist of a certain number of Wedges and their Facets, which provide core behaviour required by a distributed component that interacts with other distributed components in a well-defined and consistent manner.

In Step S01, a MeemDefinition 132 for the application defined Meem is created. Applications can define a set of one or more Wedges, their Facets and their Dependencies, which provide a given Meem with its specific personality. This MeemDefinition 132 may be created programmatically, recovered from a storage mechanism or transmitted across a communications protocol.

In Step S02, the MeemDefinition 132 is provided to a LifeCycleManager 134. All Meems are created by the LifeCycleManager 134 that maintains their LifeCycle from creation through to destruction.

In Step S03, the LifeCycleManager 134 uses the MeemBuilder 136 to create 138 the Meem. The actual process of constructing the Meem may be delegated to a specific Meem building mechanism.

In Step S04, the system defined Wedges are provided 140 to the MeemBuilder 136.

In Step S05, the MeemBuilder 136 creates 142 the system defined Meem parts. The MeemBuilder 136 examines the MeemDefinition 132 and the various parts that it contains. For each WedgeDefinition, a Wedge implementation is created. Any references between Wedges for inter-Wedge communication are resolved. For each FacetDefinition, a Facet is created, as well as method invocation Proxies for intercepting all in-bound and out-bound method calls to and from a Wedge implementation. For each DependencyDefinition, a Dependency is created. All of these parts are combined into a single Meem instance that is capable of routing in-bound method calls to the appropriate implementation code and invoking out-bound method calls on a collection of Meems.

In Step S06, the MeemBuilder 136 creates 144 the application defined Meem parts. Application specific Wedges, Facets and Dependencies are added to the Meem in a process similar to Step S05, except that, now that the Meem's system defined Wedges are in place, the MetaMeem Facet can be used to perform all Meem, Wedge, Facet and Dependency Definition altering operations.

In Step S07, the LifeCycleManager 134 assigns a MeemPath 146 to the new completed distributed object, or Meem, 148. The Meem 148 comprises a DependencyHandler 150, a MetaMeem 152, the Reference Handler 154, Application Inbound Facet 156, Wedges 158, Meem Client 160, MetaMeem Client 162, Reference Client 164, and Application Outbound Facet 166.

Meem Lifecycle

As discussed briefly above, Meems have a simple and well defined LifeCycle that marks their passage from creation, through operational states and finally destruction. A special quality of the invention is that changes in the LifeCycle state of a given Meem will also affect the state of other Meems that depend upon that Meem. These Meem Dependency relationship changes occur in a well defined and consistent manner.

Meems have three LifeCycle states and six state transitions:

Created: the Meem exists in a storage mechanism; the Meem cannot be located via MeemRegistry.

Active: the Meem is managed by a LifeCycleManager; the Meem can be located via MeemRegistry; Dependencies upon system Wedges can be resolved; Dependencies upon application Wedges can not be resolved; application specific Definitions can be altered;

Ready: Dependencies upon application Wedges can be resolved; the Meem can be used by other applications Meems; application specific Definitions can not be altered.

FIG. 8 is a flow diagram of a Meem LifeCycle according to this embodiment, including the states and transitions.

Transition 170: Meem Creation. A Meem can only be created once. Meems can only be created by a LifeCycleManager in a running system. A MeemDefinition is used to describe the Meem to be created. As the Meem is created, both its MeemDefinition and MeemContent are persisted in a storage mechanism, such as MeemStore. A Meem that exists, but is not being managed in a VM by a LifeCycleManager is in the “Created” state 172.

Transition 174: Meem Activation. A LifeCycleManager restores the MeemDefinition and MeemContent from a storage mechanism, such as MeemStore. The Meem is built using the MeemDefinition and its MeemContent is written (or placed) back into the Meem. The Meem is registered with the local MeemRegistry. The Meem's system Wedges are made available, but not its application Wedges. Other Meems that depend upon system Facets of this Meem may do so. Once this Transition is completed, the Meem is in the “Active” state 176.

Transition 178: Become Ready. The Meem attempts to resolve any Dependencies upon other. Meems. The Meem attempts to acquire any resources required by the application, such as database connections, hardware devices, etc. The Meem can only move to the “Ready” state 180 when all of its Strong Dependencies and application defined resources have been acquired.

Transition 182: Not Ready. A Meem can perform this transition for a number of reasons; any of its Strong Dependencies are lost, any of its application defined resources are lost, the Meem has an internal failure or exception thrown, the Meem itself decides to become “not ready”, another Meem requests the Meem become “not ready”, the LifeCycleManager needs to terminate, or the system is being shut-down. Any other Meems that depended upon the application Facets of this Meem are notified; the Meem is then in the “Active” state 176.

Transition 184: Deactivate. The Meem is deregistered from the local MeemRegistry. The MeemContent is updated in the storage mechanism, such as the relevant MeemStore. The Meem is deconstructed and removed from the VM. It is now in the “Created” state 172.

Transition 186: Destroy. A Meem can only be destroyed once. The MeemDefinition and MeemContent are removed from the storage mechanism, such as the relevant MeemStore. The Meem no longer exists.

Meem Dependency Resolution

A Dependency defines the relationship between Meems. A single Dependency can be associated with each Facet of a Meem. Once a Meem is registered with the MeemRegistry, then the system will attempt to resolve any Dependencies related to that Meem. A Dependency uses a MeemPath to locate a specific Meem, then an identifier to select the correct Facet. The Dependency can only be resolved by matching Facets of the correct interface type and also that out-bound Facets must be connected to in-bound Facets. The Dependency type may be either “strong”, “strongMany”, “weak” or “weakMany”. All Strong Dependencies must be resolved for the application defined Facets of a Meem to be ready for use. Weak Dependencies may be resolved or not, without affecting the Meem's readiness. StrongMany and WeakMany Dependencies mean that if the other Meem being referred to is a Category Meem, then all the Meems contained in that Category will be depended upon.

FIG. 9 is a flow diagram of Meem Dependency Resolution according to this embodiment, that is, the process by which Dependency relationships between Meems are resolved. The resolution of the Dependency between Meem M0 and Meem M1 allows Meem M0 to invoke from its Provider Facet a method defined in the Client Facet of Meem M1. The resolution of the Dependency between Meem M2 and Meem M3 allows Meem M3 to invoke from its Provider Facet a method defined in the Client Facet of Meem M2. This demonstrates that the direction of the Dependency, that is, which Meem defines the Dependency, can be independent of the direction of the Reference that is set-up.

In Step S00, Meem M1 registers 190 with MeemRegistry 192. That is, when Meem M1 moves to the “active” state, its LifeCycleManager registers 190 it with the MeemRegistry 182. As soon as Meem M1 has all its strong Dependencies resolved and all application specific resources are acquired, then the Facets of its application defined Wedges can be depended upon.

In Step S01, Meem M0 acquires 194 Reference to Meem M1. Meem M0's out-bound Provider Facet 196 has a Dependency on Meem M1, which includes both Meem M1's MeemPath and the identifier for the Facet of interest, such as “Client” Facet 198. Using the MeemRegistry 192, Meem M0 can specify the unique MeemPath of Meem M1 and thus acquire a Meem Reference to Meem M1. This Meem Reference provides access to all the system defined Facets of Meem M1.

In Step S02, Meem M0 acquires 200 Reference to Meem M1 Client Facet 198. By using the Meem M1 Reference (from Step S01), Meem M0 can utilize Meem M1's ReferenceHandler Wedge 202. This allows Meem M0 to acquire (by means of its DependencyHandler 204) specific References to any of the application defined Facets of Meem M1. In this case, Meem M0 using the identifier for the Facet of interest (such as Client Facet 198) can acquire a Reference to that Facet.

In Step S03, Meem M0 Provider Facet 196 invokes 206 on Meem M1 Client Facet 198. Using the in-bound Client Facet Reference (from Step S02), Meem M0 can update any object references that refer to that Facet. Assuming this is a strong Dependency, Meem M0 can now be moved to the “ready” state. Any events that cause Meem M0 to utilize its out-bound Provider Facet can now proceed, because the object reference to Meem M1's in-bound Client Facet 198 is now valid.

In Step S04, Meem M3 registers with MeemRegistry 192. This is similar to Step S00 above.

In Step S05, Meem M2—by means of its DependencyHandler 208—acquires 210 Reference to Meem M3. This is similar to step S01 above.

In Step S06, Meem M2—by means of its DependencyHandler 208—delivers Dependency 212 to Meem M3. Since Meem M2's Client Facet 214 is in-bound and Meem M3's Provider Facet 216 is out-bound, this dictates that the “flow of information” 218 is in the opposite direction to that of the Dependency 212. This means that the Meem defining the Dependency, in this case Meem M2, must pass that Dependency information over to Meem M3. This allows Meem M3 to create a Reference in the appropriate direction. Meem M3's system defined DependencyHandler 220 accepts such requests and causes the following Step S07 to occur as a consequence.

In Step S07, Meem M3 acquires Reference 222 to Meem M2 Client Facet 214. Using the Dependency information from step S06, Meem M3 acquires—by means of its ReferenceHandler 224 a Meem M2 Client Facet Reference in a similar fashion to Step S02 above.

In Step S08, Meem M3's Provider Facet 216 invokes 226 Meem M2 Client Facet 214. This is similar to Step S03 above.

Asynchronous Thread Decoupling

One of the standard Features provided in these embodiments is the automatic decoupling of a thread of control for method invocations between two Meems. This means that all method invocations between an out-bound Facet of a Provider Meem and the in-bound Facet of a Client Meem, are queued. This allows the thread of control that was operating in the provider Meem to continue without blocking. As required, a ThreadManager will schedule a separate thread to undertake the task of executing the method invoked on the Client Meem. The most important benefit of this approach, is that the thread of control executing in a Meem can never be blocked by the operation of another Meem.

Typically, a well-designed application system is modularized in terms of its functionality. However, also typical, is that method invocations between components in an application system will continue to call each other on the same thread. This means that complex and often unpredictable interactions may occur between components, especially when Object Oriented listener-based design patterns are employed.

By decoupling the thread of control from invocations between Meems, this invention enforces modularization in the time domain. Each in-bound method invocation can be considered purely in the context of the Meem's current state. Situations in which a thread of control leaves a Meem via an out-bound Facet and then returns via a call-back on another in-bound Facet do not need to be considered. This reduces the complexity of designing a distributed application.

Meem Developer Tool

This section provides a concrete example of how the invention might be used to solve a simple problem in the automation of real world hardware devices. This example is just one of many varied application problems domains to which the invention may be applied.

The basic problem is how to use distributed components to individually model all devices in an automation application. The goal is to provide a system that allows application developers to focus on the specifics of the device models. This requires the system, as described by this invention, to provide a consistent process for dynamic discovery of devices, flexible interconnection of those devices (when it makes sense), asynchronous flow of information between devices and handling of failure in any of the devices including automatic recovery (when possible).

FIG. 10 is a flow diagram of a simple automation application, comprising an arrangement of devices that are typically found in automating real world hardware.

In this case, a user input “Switch” is to be connected to the “Light”, as represented by software objects. To control the actual Light hardware device, there is usually some sort of “Hardware Adapter”, such as X-10 or Echelon LONWorks. This Hardware Adapter can also be modelled in software as another component of the automation application.

According to this embodiment, and referring to FIG. 10, each component is represented in software by a Meem: a Switch Meem 230 connected to a Light Meem 232. The light hardware 234 is controlled by a Hardware Adapter 236, by means of a Hardware Adapter Meem 238. These Meems have well-defined interfaces that appear as in-bound or out-bound Facets, corresponding to the functionality of the device. Devices that have a binary state, such as on or off, can be modelled as a Latch that can be enabled or disabled by method calls. For example, the Light Meem 232 would have an in-bound Latch Facet called “control” and an out-bound Latch called “state”.

These Latch Facets can be depended upon by any other Meem that also has a Latch Facet. Noting that an out-bound Facet must always be connected to an in-bound Facet. It is quite possible for an application developer to use this embodiment and to manually construct the solution described above. However, the platform of this embodiment provides a set of graphical tools that simplify the process and provide a visual representation of the application system being developed. This is depicted as a screen-grab in FIG. 11. A special quality of the invention is that, as described above, new Meems can be created or existing Meems modified (including their definition) or destroyed whilst the system is operational. This is particularly noteworthy, and allows the tool illustrated in FIG. 11 to operates without having to restart the system.

Referring to FIG. 11, Step S00 indicates MeemKit 240, a toolbox containing various Meem types. The MeemKit assists the application developer so that he or she does not have to construct the same basic MeemDefinitions over and over again. New Meem types can be dragged and dropped into the MeemKit. Existing Meem types can be dragged from the MeemKit and a copy will be created and dropped whereever it is required. As shown, MeemKit 240 includes a Switch Meem, a Light Meem, a site Meem and a System Meem.

In Step S01, a template Light Meem exists and is displayed in the MeemKit 242, so a Light MeemDefinition containing the WedgeDefinitions and Latch FacetDefinitions exists in MeemStore. The MeemKit 240 can group related types of Meems together. The MeemKit Automation group (the group depicted) contains the unique MeemPath for the Light MeemDefinition in MeemStore. This Light Meem is no different from any other Meem, but—being a “template”—when it is dragged from MeemKit, a new copy is made.

In Step S02, a new Light Meem is created. By selecting and dragging a Light Meem from the MeemKit 240 to a Category in HyperSpace 242, the following occurs. The Light MeemDefinition is given to a LifeCycleManager, which dynamically creates a new Meem. The MeemDefinition representing the Light Meem is stored in MeemStore, so that the Light Meem can be reactivated by a LifeCycleManager. The unique MeemPath for that Light Meem is stored in a Category in HyperSpace, so that the Light Meem can be located when needed. The Light Meem will now be in an “active” state.

In Step S03, the Light Meem is placed in the Meem Editor 244. By selecting and dragging the Light Meem from HyperSpace 242 into the Meem Editor 244 the following occurs. The Meem Editor 244 acquires a Meem Reference to the Light Meem. Using the Meem Reference the Meem Editor 244 can then utilize the MetaMeem and MetaMeemClient Facets to inspect the MeemDefinition and alter the MeemDefinition as required. The Light MeemDefinition is displayed in detail.

In Step S04, a template Switch Meem exists in and is displayed in the MeemKit 240. This is similar to Step S01 above.

In Step S05, a new Switch Meem is created. This is similar to Step S02 above.

In Step S06, the Switch Meem is placed in the Meem Editor 244. This is similar to Step S03 above.

In Step S07, a Dependency is made from the Switch to the Light. By selecting the Switch Meem's out-bound Latch Facet and dragging it to the Light Meem's in-bound Latch Facet, the Meem Editor will use the Switch Meem's MetaMeem Facet to add a new Dependency to the Switch Meem.

In Step S08 (not shown), a Hardware Adapter Meem is created. This is similar to Steps S01 to S03 above.

In Step S09 (not shown), the Light Meem depends upon the Hardware Adapter Meem. This is similar to Step S07 above.

In Step S10 (not shown), the Meems are moved to the “ready” state. Within the Meem Editor 244, the Light, Switch and Hardware Adapter Meems are selected and are requested to move to the “ready” state. This will cause the Dependencies between the Switch Meem and the Light Meem, as well as the Light Meem and Hardware Adapter Meem to be resolved. The process of resolving Dependencies is described above (see in particular Steps S25 to S28 of FIG. 6 and S00 to S08 of FIG. 9).

This process results in three operational Meems that represent hardware in the automation system. These Meems depend upon each other, such that dynamic discovery of each Meem can cause a Dependency to be resolved to a usable Reference. The References between Facets of the Meems allows operations on the Switch Meem to cause operations on the Light Meem and then the Hardware Adapter Meem, as required. Failure in the software or hardware represented by the Meems will cause a Meem to fail and become “not ready”. In turn, this will make the Dependencies break, leaving the dependent Meems “not ready”, until the problem is resolved.

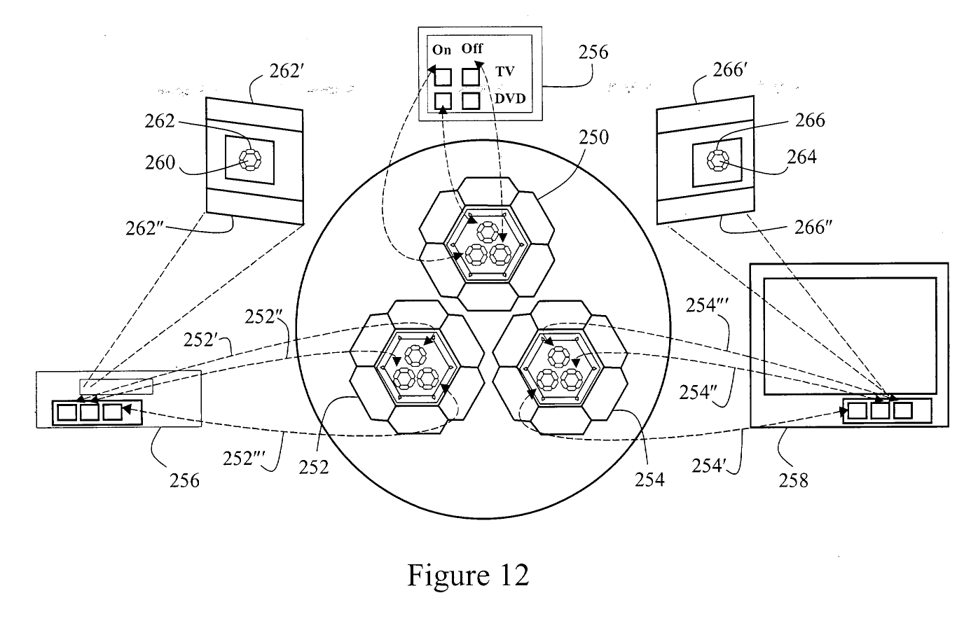

FIG. 12 is a schematic diagram illustrating a further example of the distributed system of this embodiment, for use with a home theatre system.

In this example, three Meems are created: a Home Theatre Application Meem 250, a DVD Manager 252 and a Television Manager 254. These Meems are controlled via a web browser 256, which displays software ON and OFF controls for both the corresponding DVD player 256 and television 258. The distributing system of this embodiment is also running across the DVD player 256 and the television 258.

The Home Theatre Application Meem 250 thus includes three Meems, an ON Meem, an OFF Meem and a device Meem (for switching between control of the DVD player 256 and the television 258). DVD Manager Meem 252 includes three Meems: a first 252′ for controlling the ON/OFF function of the DVD player 256, a second 252″ for controlling the PLAY function of the DVD player 256 and a third 252″′ for controlling the STOP function of the DVD player 256.

Television Manager Meem 254 includes three Meems: a first 254′ for controlling the ON/OFF function of the television 258, a second 254″ for controlling the Channel selector of the television 258 and a third 254″40 for controlling the volume control of the television 258.

The DVD player 256 includes a device controller 260, interchangeable between, for example, IR, Serial and USB communication, and contains the manufacturer's software implementation (IMPL) and authentication certificate. A general purpose Meem 262 (with a client connector 262′ and a host connector 262″) is created so that the IMPL can be included in the distributed system and communicate with the other Meems.

The television 258 includes a similar controller 264, and a general purpose Meem 266 (with a client connector 266′ and a host connector 266″) is created so that the television's IMPL can be included in the distributed system and communicate with the other Meems.

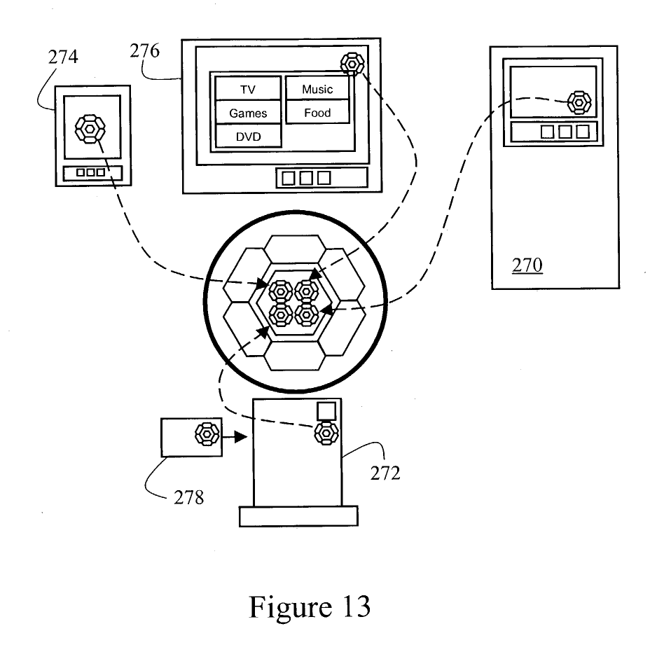

Another home automation example of the present embodiment is shown in FIG. 13. This example is comparable to that shown in FIG. 12, but involves an internet fridge 270, a games console 272 (which also acts a server), an MP3 player 274, and a television 276. Each device communicates with the server and are all therefore in communication as part of the distributed software environment of this embodiment. The server contains an authentication profile, home automation application software 278, the manufacturer IMPL and authentication certificate.

The home automation application software 278 can be controlled by means of a series of control screen displayable on the television 276, once a suitable Meem incorporating that software has been created.

USE WITH THE .NET (TM) AND J2EE (TM) PLATFORMS The platform, system and development tools of the above embodiments provides a set of services and APIs based on top of the Java (TM) language and the extensive Java 2 Standard Edition (TM) platform, so its use does not exclude interoperating with J2EE (TM) application systems and components. Rather, it addresses a set of problems than neither the .NET (TM) platform nor the J2EE (TM) platform addresses, and does not attempt to replicate their functionality, at least in the area of traditional database applications (OO/Relational DataBase mapping) or web services (exchange and presentation of XML). It is quite possible to wrap the components of this embodiment (viz. Meems) as J2EE (TM) components or web services. Conversely, it is also possible to wrap J2EE (TM) components and web services as Meems.

The following are the key differences between these embodiments and the .NET (TM) and J2EE (TM) platforms.

Firstly, it will be understood from the foregoing that the platform and system of the above-described embodiments are built using the same concepts it provides to the applications.

The platform and system provide a set of functionality for creating distributed systems. Since nearly all of the key Features are designed and implemented as Meems, software environments constructing according to this embodiment benefit from those same Features provided for application developers. At a fundamental level, therefore, a software environment according to this embodiment is modular, distributed, resilient and secure.

1. Component Construction

The above embodiments include a declarative mechanism by which a distributed component can be constructed from smaller pieces, each of which comprises a Java (TM) language interface and implementation. These pieces provide a more sophisticated contract for both in-bound and out-bound interactions than can be formed in, for example, the .NET (TM) or the J2EE (TM) platforms.

2. Relationships Between Components

The above embodiments include a declarative mechanism for the dynamic between distributed components (Meems). Components can appear, disappear, move around and be replaced, all on-the-fly, without compromising the whole application system. As part of the component dependency mechanism, the results of a failure between components is well-defined (as is discussed below).

3. Consistent Handling of Distributed Component Failure

Underlying distributed systems frameworks, such as the Jini (TM) platform, provide the base technology for connecting distributed components and dealing with failure conditions. Usually, the decision of exactly how to utilize the technology is left to the application developer. The present embodiment provides a consistent approach to failure that provides a higher-level abstraction for the developer.

4. Fully Asynchronous Semantics

A distributed system of the above embodiments supports proactive information exchanges between components, rather than by client-side requests. One component can depend upon another, and based upon the circumstances can define the flow of information to be in the same direction as the dependency, or vice-versa. Also, the component can specify whether it requires the other component to send its current state whenever the dependency is resolved.

5. Intercomponent Thread Decoupling

To prevent thread blocking by other components, all method invocations on other components are decoupled by queuing the invocation for later execution by other thread. This means that the liveness of a component cannot be affected by indeterminate behaviour of any other component. By default, it is assumed that components are not reentrant, and method invocation within a component is single-threaded. A component can be declared to be multi-threaded.

6. Asynchronous Component Configuration

The meems of the present embodiment can support being configured (that is, subjected to ad hoc changes of component attributes) at any time during run-time. This allows configuration to occur without having to stop and restart components or large parts of a system.

7. Distributed Component Security

Authentication of client and provider components, as well as encryption of the information flow, is controlled by declaration, which is transparent to the application developer. The platform and software environment of the present embodiment provides security consistently between every component, potentially protecting all interactions between components.

8. Distributed Component Diagnosis

Capturing and play-back of component interactions (using the Flight Recorder), allows problems concerning the inconsistencies between component behaviour to be studied.

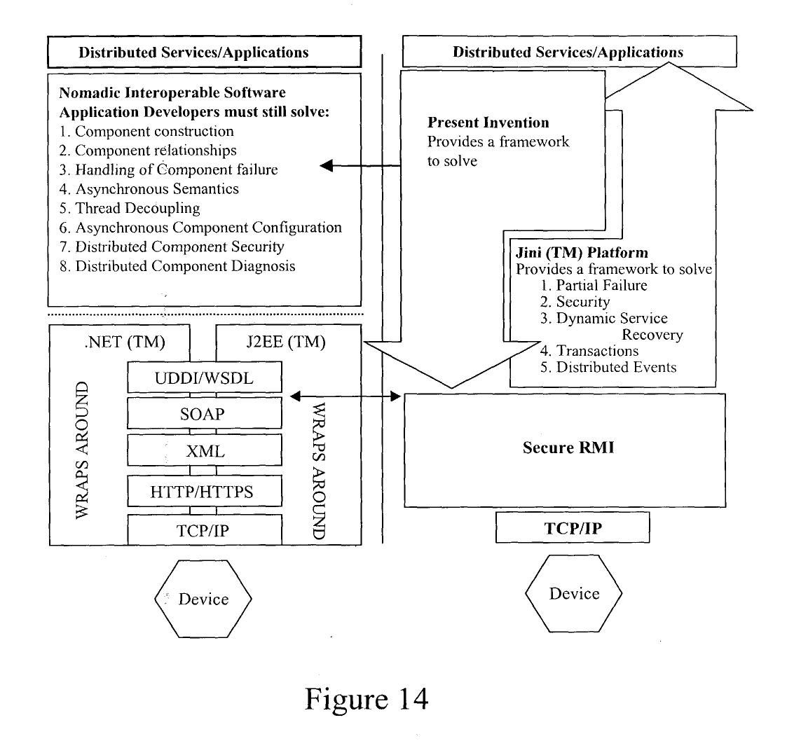

FIG. 14 summarizes these differences, and is an architectural diagram comparing the differences between existing techniques (left column) and the approach of the preferred embodiments of the present invention (right column).

Modifications within the scope of the invention may be readily effected by those skilled in the art. It is to be understood, therefore, that this invention is not limited to the particular embodiments described by way of example hereinabove.

Further, any reference herein to prior art is not intended to imply that such prior art forms or formed a part of the common general knowledge.

The claims defining the invention are as follows:

1. A software development platform for allowing a software developer to develop an application that consists of one or more software modules, the platform being operable to independently provide each of the software modules with at least one component that allows the software modules to operate as distributed objects.

2. A software development platform as claimed in claim 1, wherein said component comprises an interface for handling an operational call into or out of the component, and software capable of carrying out said operational call.

3. A software development platform as claimed in claim 1, wherein said platform allows the software developer to specify for said component a type, a name, and whether operational calls are in bound or out bound.

4. A software development platform as claimed in claim 1, wherein said platform is operable to programmatically or declaratively define a selection of components and software modules as a strongly encapsulated and self-contained distributed object.

5. A software development platform as claimed in claim 1, wherein said platform is operable to construct said component to perform one or more of thread control, operational call logging, distributed operational calls, authentication, encryption and broadcasting of operational calls.

6. A software development platform as claimed in claim 5, wherein said platform is operable to construct said component to perform one or more of thread control, operational call logging, distributed operational calls, authentication, encryption and broadcasting of operational calls in a manner that is transparent to the software developer.

7. A software development platform as claimed in claim 1, wherein said platform is operable to provide one or more system defined components for performing one or more of lifecycle, usability, association management, persistence and configuration.

8. A software development platform as claimed in claim 1, wherein said platform is operable to provide one or more system components for adding, modifying or removing any of the components and/or software modules that constitute a respective one of said distributed objects.

9. A software development platform as claimed in claim 8, wherein said respective one of said distributed objects includes said one or more system components for adding, modifying or removing.

10. A software development platform as claimed in claim 1, wherein said platform is operable to create, update or destroy any distributed object managed by said platform whilst said platform is operational.

11. A software development platform as claimed in claim 1, wherein said platform is a first of a plurality of such software development platforms and is operable to allow the transfer of a distributed object from said first platform to another of said plurality of platforms whilst said first platform and said other platform are operational.

12. A software development platform as claimed in claim 1, wherein said platform is operable to develop user defined components that can be automatically linked to other of said components according to type or name.

13. A software development platform as claimed in claim 1, wherein said platform is operable to alter the lifecycle state of any one of said distributed objects according to any association between said distributed object and any other distributed object and/or according to removal of said association.

14. A software development platform as claimed in claim 1, wherein said platform is operable to form one or more associations between any two of said distributed objects automatically.

15. A software development platform as claimed in claim 1, wherein said platform is operable to construct said component so as to queue in bound and/or out bound operational calls that are asynchronously invoked and thereby allow a current thread of control to continue processing without being blocked and a further thread of control to dequeue and continue the invocation of the operational call, whereby the invocation and execution of an operational call can be decoupled.

16. A software development platform as claimed in claim 1, wherein any one or more of said at least one component is constructed by means of the Jini (TM) platform.

17. A software development platform as claimed in claim 1, wherein any one or more of said one or more software modules is constructed by means of the Jini (TM) platform.

18. A software development platform as claimed in claim 1, wherein said platform is operable to provide each of the software modules with a plurality of such components.

19. A software development platform as claimed in claim 1, wherein said platform is operable to allow the programmatic or declarative definition of a compound distributed object comprising a plurality of said distributed objects, whereby said compound distributed object is strongly encapsulated and self-contained.

20. A software application developed using the software development platform claimed in claim 1.

21. A distributed object developed using the software development platform claimed in claim 1.

22. A distributed object as claimed in claim 21, wherein at least a part of said distributed object is constructed by means of the Jini (TM) platform.

23. An application development method for allowing a software developer to develop an application that consists of one or more software modules, the method comprising the step of independently providing the software modules with at least one component that allows the software modules to operate as distributed software objects.

24. A software development platform, wherein said platform is operable to develop one or more software components that allow one or more software modules that constitute a software application to operate as distributed software components.

25. A software development tool, wherein said tool is operable to develop one or more software components that allow one or more software modules that constitute a software application to operate as distributed software components.

26. An electronic device provided with and controllable by an application developed by means of the software development platform of claim 1.

27. A software development framework for allowing a software developer to develop an application that consists of one or more software modules, the platform being operable to independently provide each of the software modules with at least one component that allows the software modules to operate as distributed objects.
